(19) United States
(12) Patent Application Publication
(10) Pub. No.: US 2005/0073408 A1
(43) Pub. Date: Apr. 7, 2005

(54) Multi-functional and portable ersonal emergency SOS device

(76) Inventors: Huei-Hsin Sun, Taipei City (TW); Yu-Yu Chuang, Banciao City (TW); Tien-Cheng Hu, Banciao City (TW)

Correspondence Address: TROXELL LAW OFFICE PLLC;SUITE 1404, 5205 LEESBURG PIKE, FALLS CHURCH, VA, 22041, US

(21) Appl. No.: 10/843,317

(22) Filed: May 12, 2004

(30) Foreign Application Priority Data
Oct. 2, 2003 (TW) 092217684

(51) Int. Cl. G08B 1/08

(52) U.S. Cl. 340/539.13; 340/573.1

(57) ABSTRACT

A multi-functional and portable personal emergency SOS device is provided. The emergency SOS device includes a control module, a human machine interface module, a communication channel module, a circumstance detecting module and a physical condition detecting module. When the user is encountering an accident or a particular situation, said emergency SOS device according to the present invention can send out a mayday signal including an ID, a position or physical conditions of the user through one or more different communication channel medium manually or automatically so that the searching and rescuing can process quickly.

### BACKGROUND OF THE INVENTION

1. Field of the Invention

The present invention is related to a multi-functional and portable personal emergency SOS device, and more particularly to a multi-functional and portable personal emergency SOS device which can send out a mayday signal through a different communication manner when the user is suffering an accident so that the search and rescue system centers or stations can be informed immediately and do some help timely.

2. Description of the Prior Art

Presently, because outdoorsmen is sharply increased, the proprietor has investigated to develop a portable emergency SOS device for the outdoorsmen. And, the emergency device can send out a mayday signal through a communication channel when there shows an accident so that the search and rescue system centers or stations may execute the rescue timely. However, this conventional kind of emergency SOS device still has some defects as follows:

1. The conventional emergency SOS device only employs one single communication channel, and thus, if the user is located at a position without a communication signal thereof, the functions of the emergency device will be abnormal, and a normal efficiency of the emergency SOS device is undoubtedly no use.

2. When some accidents are happened, the user might lose his conscious at the first time, and thus it is difficult for the user to initiate the emergency SOS device immediately and therefore, the user will miss the prime time for rescue.

3. The current conventional emergency SOS device is however hindered by the circumstance, and thus, the groups using this device are also influenced so that it might not be popularized.

Thus, it can be seen, the prior art described above still has some defects, is not a good design, however, and is urgently to be improved.

Because of the technical defects of described above, the applicant keeps on carving unflaggingly to develop multi-functional and portable personal emergency SOS device through wholehearted experience and research.

### SUMMARY OF THE INVENTION

These features and advantages of the present invention will be fully understood and appreciated from the following detailed description of the accompanying Drawings.

One object of the present invention is to provide a multi-functional and portable personal emergency SOS device which has multiple communication channels (for example, RF, GSM and GPRS etc.) and can automatically switch to one of those channels depending on the circumstances so as to ensure an effective transmission signal. If the public GSM utility system unit can not communicate with the signals owing to the something circumstances, for example, when the sufferer is buried in the snow, the RF will automatically switched on and then continuously send out a radio frequency beacon signal with intermittent pulse for mayday signal so that the power can be lasted for a longer time and extend the operation of the device for facilitating the rescue.

Another object of the present invention is to provide a multi-functional and portable personal emergency SOS device which provides an audio control or a manual control method to send out a mayday signal while the user is conscious, and also provide an automatic mayday signal sending out method when the user encounter some abnormal movement impact (for example, if the movement impact acceleration is larger than several gravity G) is detected by a circumstance detecting module result in the user unconscious owing to falling down or being hit.

Another further object of the present invention is to provide a multi-functional and portable personal emergency SOS device which can record and compare the physical conditions of the user through a physical condition detecting module so that it can dedicate an early warning signal to the user whenever the users' body temperature, heartbeat or blood pressure is abnormal, and thus, the user can understand the situation and proceed a proper process before the users' physiology condition become worse.

Still another object of the present invention is to provide a multi-functional and portable personal emergency SOS device which has functions of audio dialing, audio mayday shouts and audio reporting clock time so that the user can operate in the dark and can be easy operated for the blind as well.

For achieving the objects described above, the multi-functional and portable personal emergency SOS device according to the present invention includes a control module, a human machine interface module, a communication channel module, a circumstance detecting module and a body condition detecting module. When the user is encountering an accident or a particular situation, the emergency SOS device according to the present condition can will transmit a mayday signal including an ID, a position or physical messages of the user through one or more different communication channel medium manually or automatically so that the search and rescue system centers or stations can prepare to arrive and rescue quickly.

### BRIEF DESCRIPTION OF THE DRAWINGS

FIG. 1A block diagram of a multi-functional and portable personal emergency SOS device according to the present invention; and

FIG. 2A practically schematic view of the multi-functional and portable personal emergency SOS device combined with a ring structure.

### DETAILED DESCRIPTION OF THE PREFERRED EMBODIMENT

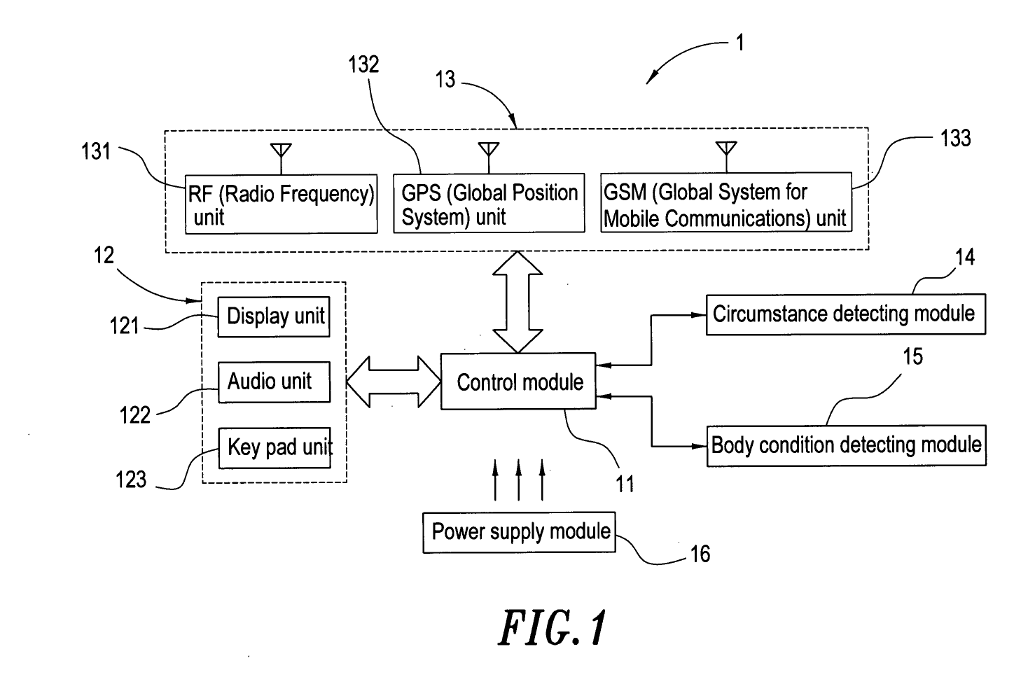

Please refer to FIG. 1, which illustrates a block diagram showing a multi-functional and portable personal emergency SOS device. As shown in FIG. 1, the emergency SOS device 1 includes:
a control module 11 connected to a human machine interface module 12, a communication channel module 13, a circumstance detecting module 14 and a body condition detecting module 15, wherein the control module 11 receives signals from each module and then outputs a corresponding control signal to each corresponding module after judging, processing or storing the signals;
a human machine interface module 12, which comprises a display unit 121, an audio unit 122 and a key pad unit 123, is connected to the control module 11 and shows a performance of the emergency SOS device 1 to the user through a display or an audio manner or transmits a command from the user to the emergency SOS device 1 through a key pad or an audio;
a communication channel module 13, which comprises a radio frequency (RF) unit 131, a GPS (Global Position System) unit 132 and a GSM (Global System for Mobile Communications) unit 133, is connected to the control module 11 and provides a correct geographic position or selects a proper transmission medium to send out a mayday signal;
a circumstance detecting module 14, which is connected to the control module 11 and transmits a signal of a normal or a abnormal movement condition of the user (such as conditions of falling down or punching) to the control module 11 through a movement detector (including a bridle detector, a detector for acceleration of gravity and an atmospheric pressure detector) to be a basis of the mayday signal, and if the public GSM unit can not send out the signals owing to the circumstances, for example, when the sufferer is buried in the snow, the debris, or falling into the ravine, the RF unit 131 will intermittently send out a radio frequency beacon for facilitating the rescuer;
a physical condition detecting module 15, which is connected to the control module 11 and judges physical conditions (such as signals of body temperature, heartbeat, blood pressure) of the user through a physical sensor so that the physical conditions will be properly transmitted to the control module 11 to be a basis of the mayday signal; and
a power supply module 16 for supplying power to each module in the emergency SOS device 1.

When the user is encountering an accident or a particular situation, the emergency SOS device according to the present invention can send out a mayday signal including an ID, a position or physical conditions of the user through one or more different communication channel medium manually or automatically so that the search and rescue system centers or stations can prepare to arrive and rescue quickly.

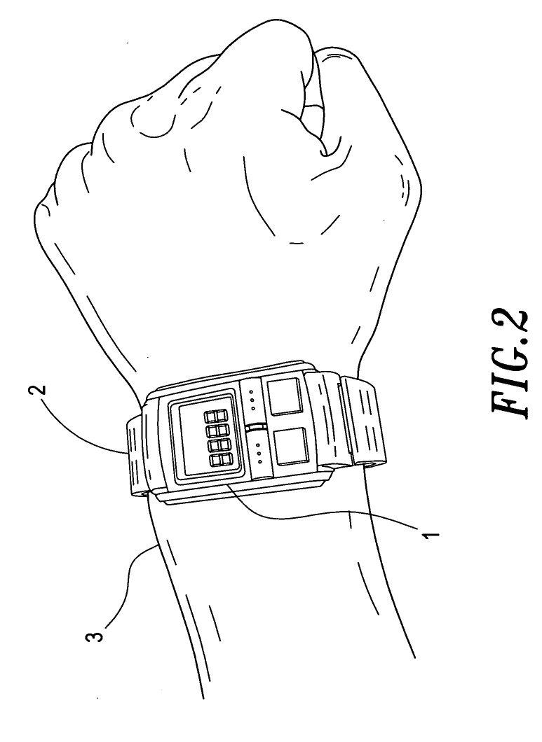

Please refer to FIG. 2, which is a practically schematic view showing the multi-functional and portable personal emergency SOS device combined with a ring structure. As shown in FIG. 2, each module of the emergency SOS device 1 according to the present invention can be a chip migration to reduce a volume thereof for being positioned on a ring structure 2 (for example, a watch etc.) so that the user can conveniently wear the emergency SOS device 1 on the wrist 3 as engaging in an activity, or the emergency SOS device 1 can be manufactured into a case or a box for convenient carrying.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

1. A multi-functional and portable personal emergency SOS device, comprising:
a control module connected to a human machine interface module, a communication channel module, a circumstance detecting module and a physical condition detecting module, said control module receiving signals from each module and then outputting a corresponding control signal to each corresponding module after judging, processing or storing said signals;
a human machine interface module connected to said control module and showing a performance of said emergency SOS device to the user through a display or an audio manner or transmitting a command from the user to said emergency SOS device through a key pad or an audio;
a communication channel module connected to said control module and providing a correct geographic position or selecting a proper transmission medium to send out a mayday signal;
a circumstance detecting module connected to said control module and transmitting a signal of a normal or a abnormal movement condition of the user to said control module through a movement detector to be a basis of said mayday signal;
a body condition detecting module connected to said control module and judging physical conditions of the user through a physical detector so that said physical conditions is properly transmitted to said control module to be a basis of said mayday signal; and
a power supply module for supplying power to each module in said emergency SOS device,
wherein when the user is suffering an accident or a particular situation, said emergency SOS device sends out a mayday signal including an ID, a position or physical conditions of the user through a communication channel of one or more different medium by a manual or an automatic manner so that the search and rescue system centers or stations can arrive and rescue quickly.

2. The emergency SOS device as claimed in claim 1, wherein said human machine interface comprises a display unit, an audio unit and a key pad unit.

3. The emergency SOS device as claimed in claim 1, wherein said communication channel module comprises a RF (Radio Frequency) unit, a GPS (Global Position System) unit and a GSM (Global System for Mobile Communications) unit.

4. The emergency SOS device as claimed in claim 1, wherein said movement detector comprises a bridle detector, a detector for acceleration of gravity and an atmospheric pressure detector.

5. The emergency SOS device as claimed in claim 1, wherein said physical detector comprises a body temperature detector, a heartbeat detector, a blood pressure detector or skin detector.

6. The emergency SOS device as claimed in claim 1, wherein each module of said emergency SOS device is a chip migration depending on a demand to reduce a volume thereof for being positioned on a proper structure.

7. The emergency SOS device as claimed in claim 6, wherein each module of said emergency SOS device is manufactured into a ring structure or a case for carrying.
